(19) United States
(12) Patent Application Publication
(10) Pub. No.: US 2018/0051494 A1
(43) Pub. Date: Feb. 22, 2018

(54) LOCK FOR MOTOR VEHICLE DOOR OR LID

(71) Applicant: CEBI ITALY S.P.A., Dronero (CN) (IT)

(72) Inventor: Marco SCOCCO, Recanati (MC) (IT)

(21) Appl. No.: 15/676,230

(22) Filed: Aug. 14, 2017

(30) Foreign Application Priority Data
Aug. 17, 2016 (IT) 102016000085579

(51) Int. Cl. E05B 81/90; E05B 81/16; E05B 81/34

(52) U.S. Cl. CPC E05B 81/90; E05B 81/16; E05B 83/18; E05Y 2900/548; E05B 81/34

(57) ABSTRACT

A lock for a motor vehicle door or lid has a lock hook, a locking latch actuating on the lock hook to block the lock hook in closing position, an actuation lever intended to actuate the lock hook, an electrical motor that actuates the actuation lever by means of a transmission, and an emergency opening device that can be manually actuated by the user to open the lock when the electrical motor is blocked.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The present patent application for industrial invention relates to a lock for a motor vehicle door or lid, in particular for the trunk of a vehicle.

### 2. Description of Related Art Including Information Disclosed Under 37 CFR 1.97 and 37 CFR 1.98.

Various types of locks for motor vehicle doors or lids are known on the market. Said locks comprise a lock hook that is engaged into a “U”-shaped pin fixed to the body of the vehicle.

The lock hook is actuated by an electrical motor by means of a transmission with gears and levers. A stop lever, which is normally known as a locking latch, is engaged with the lock hook in order to block the lock hook and keep it in closed position.

In such a type of locks, if the motor is blocked, the lock hook remains blocked in closed position by the locking latch, preventing the lock from being opened.

In order to remedy such a drawback, locks with two motors are known: a large motor actuates the gears and the levers that are used to actuate the lock hook and a smaller motor actuates the locking latch. Obviously, this type of locks is cumbersome and expensive because they are provided with two motors. Moreover, if the large motor remains blocked, also the lock hook will be blocked. In fact, the actuation of the small motor will release the locking latch, but not the lock hook, which will remain blocked. Several systems are available to disengage the lock hook by disconnecting the transmission or by disconnecting the levers.

Such a drawback is partially solved by locks provided with only one motor with epicycloid reduction gear and an emergency release system that provides for manually actuating a lever that is translated to sublet the epicycloid reduction gear of the motor and allow for the rotation of the lock hook into the opening position. However, such an emergency release system is complex and cumbersome due to the presence of several lever mechanisms. Moreover, such an emergency release system is difficult to be actuated by the user, who needs to disengage the locking latch from the lock hook and then actuate the lock hook.

The purpose of the present invention is to eliminate the drawbacks of the prior art by providing a lock for a vehicle door or lid that is reliable and easy to detach when the motor of the lock is blocked.

Another purpose of the present invention is to disclose such a lock for a vehicle door or lid that is not cumbersome and is easy to make and assemble.

### BRIEF SUMMARY OF THE INVENTION

These purposes are achieved according to the invention with the characteristics of the independent claim 1.

Advantageous embodiments of the invention appear from the dependent claims.

The lock for vehicle door or lid according to the invention comprises:
a closing hook hinged to a box of the lock, around a pivoting axis, said closing hook comprising a slot intended to hook a pin fixed to the motor vehicle body,
a locking latch hinged to the box of the lock around a pivoting pin and acting on said lock hook to lock the lock hook in closing position;
an actuation lever intended to actuate said lock hook,
an electrical motor that actuates said actuation lever by means of a transmission, and
an emergency opening device that can be manually actuated by the user to open the lock when the electrical motor is blocked.

The emergency opening device comprises:
a first lever detachably hooked to said actuation lever, and
a second lever that cooperates with the first lever and acts on said locking latch to release the locking latch from the locking position in which it locks the lock hook.

In this way, by manually operating the first lever, the operator can release both the locking latch and the lock hook.

### BRIEF DESCRIPTION OF THE SEVERAL VIEWS OF THE DRAWINGS

Additional features of the invention will appear manifest from the detailed description below, which refers to merely a illustrative, not limiting embodiment, as illustrated in the attached figures, wherein:

FIGS. 1 and 2 are two perspective views taken from different angles, which show the lock of the invention in a neutral position;

FIG. 3 is a perspective view of a lock hook of the lock according to the invention;

FIG. 4 is a perspective view of a locking latch of the lock according to the invention;

FIGS. 5 are 6 perspective views that show the gear of the lock according to the invention from different sides;

FIG. 7 is a perspective view of a connection lever of the lock according to the invention;

FIGS. 8 and 9 are perspective views that show an actuation lever of the lock according to the invention from different sides;

FIG. 10 is a perspective view of a lever used to detect the position of the lock according to the invention;

FIGS. 11 are 12 perspective views that show two levers of an emergency opening device of the lock according to the invention;

FIGS. 13 and 14 are two perspective views taken from different angles, which show the lock of the invention in a closing position;

FIGS. 15 and 16 are two perspective views taken from different angles, which show the lock of the invention in an electronic opening position;

FIGS. 17 and 18 are two perspective views taken from different angles, which show the lock of the invention in a manual emergency opening position.

### DETAILED DESCRIPTION OF THE INVENTION

With reference to the Figures, the lock of the invention is disclosed, which is generally indicated with reference numeral (100).

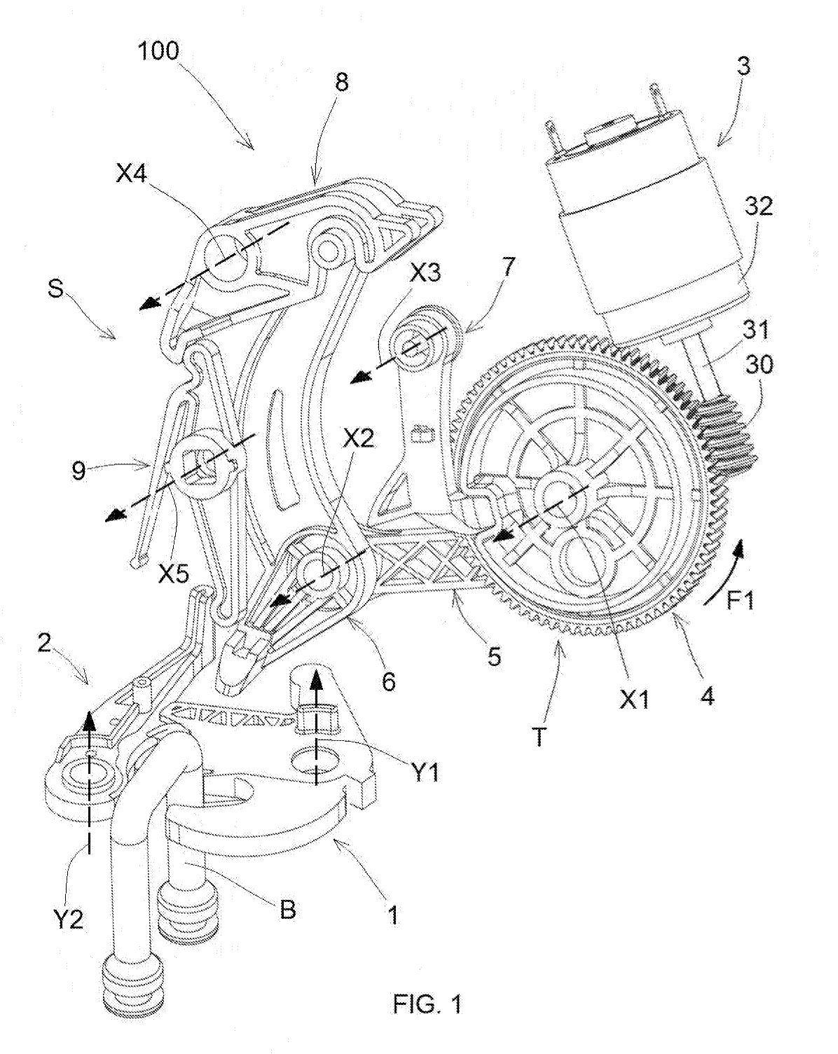

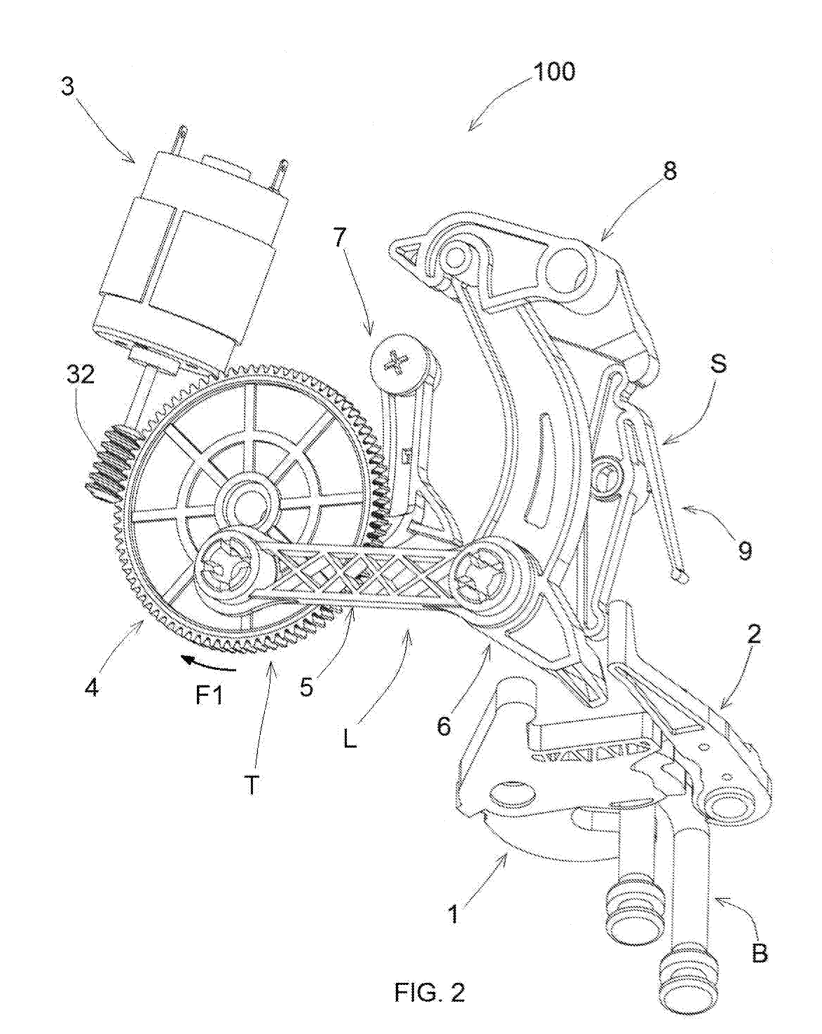

Now with reference to FIGS. 1 and 2, the lock (100) comprises a lock hook (1) intended to be engaged to a “U”-shaped pin (B). The pin (B) is fixed to the body of the vehicle. Instead the lock (100) is disposed in a box or casing fixed to the door or lid of the vehicle.

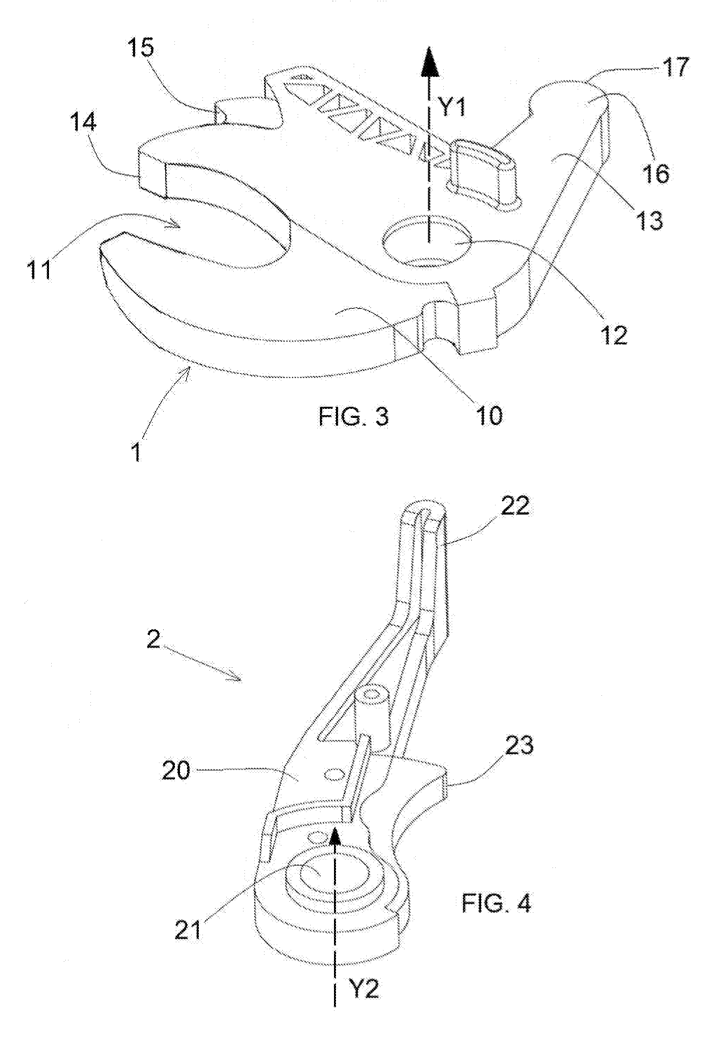

With reference to FIG. 3, the lock hook (1) has a plate-shaped body (10) provided with a “U”-shaped slot (11) intended to hook the pin (B).

A pivoting hole (12) is obtained in the body (10) of the lock hook for pivoting the lock hook in the box that contains the lock, around a pivoting pin (X1).

The lock hook (1) comprises an arm (13) that extends in substantially orthogonal direction with respect to the direction of the slot (11). The arm (13) is intended to actuate the lock hook. The arm (13) ends with a tooth (16) provided with a rounded end (17).

A locking seat (14) is disposed in one edge of the slot (11). A positioning seat (15) is disposed on one edge of the body of the lock hook, outside of the slot.

Going back to FIGS. 1 and 2, a stop lever or locking latch (2) cooperates with the lock hook (1) to lock and hold the lock hook in closing position.

With reference to FIG. 4, the locking latch (2) has a rod-shaped body (20). A pivoting hole (21) is obtained at one first end of the body (20) in order to pivot the locking latch to the box of the lock with a pivoting axis (X2) parallel to the pivoting axis (X1) of the closing hook.

An actuation projection (22) protrudes from a second end of the body (20) in a parallel direction to the pivoting axis of the locking latch. A stop tooth (23) protrudes from the body (20) in an intermediate position between the pivoting hole (21) and the actuation projection (22). The stop tooth (23) faces the lock hook (1). A spring (not shown) stresses the locking latch (2) towards the lock hook (1).

As shown in FIGS. 1 and 2, in a non-closing neutral position, the stop tooth (23) of the locking latch is disposed in the positioning seat (15) of the lock hook, allowing for the movement of the lock hook.

An actuation lever (6) actuates the lock hook (1). The actuation lever (6) is actuated by means of an electrical motor (3) and a transmission (T) comprising a gear (4) and a connection lever (5). The electrical motor (3) comprises a geared motor (30) having an output shaft (31) on which a worm screw (32) that engages in said gear (4) is mounted.

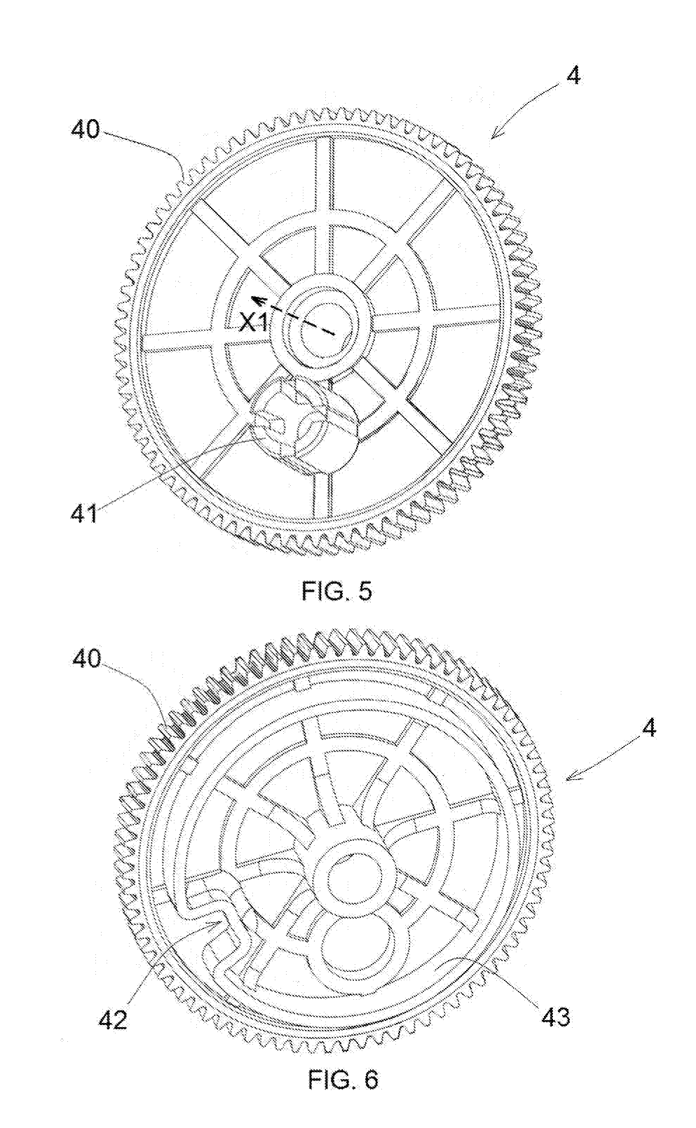

With reference to FIGS. 5 and 6, the gear (4) comprises a toothed wheel provided with an external toothing (40) intended to engage with the worm screw (32). The gear (4) has an axis of rotation (X1) that is inclined with respect to the pivoting axes (Y1, Y2) of the hook lock and of the locking latch. Such inclination can be of approximately 120°.

With reference to FIG. 5, an eccentric pin (41) protrudes from one side of the gear in peripheral position with respect to the axis of rotation of the gear.

With reference to FIG. 6, a housing (42) is obtained on one side of the gear in opposite position to the side where the eccentric pin (41) is situated. The housing (42) is obtained in peripheral position with respect to the axis of rotation of the gear. In particular, a peripheral cylindrical collar (43) protrudes from the side of the gear opposite to the side with the eccentric pin. The housing (42) is obtained as a radial recess of the peripheral cylindrical collar (43).

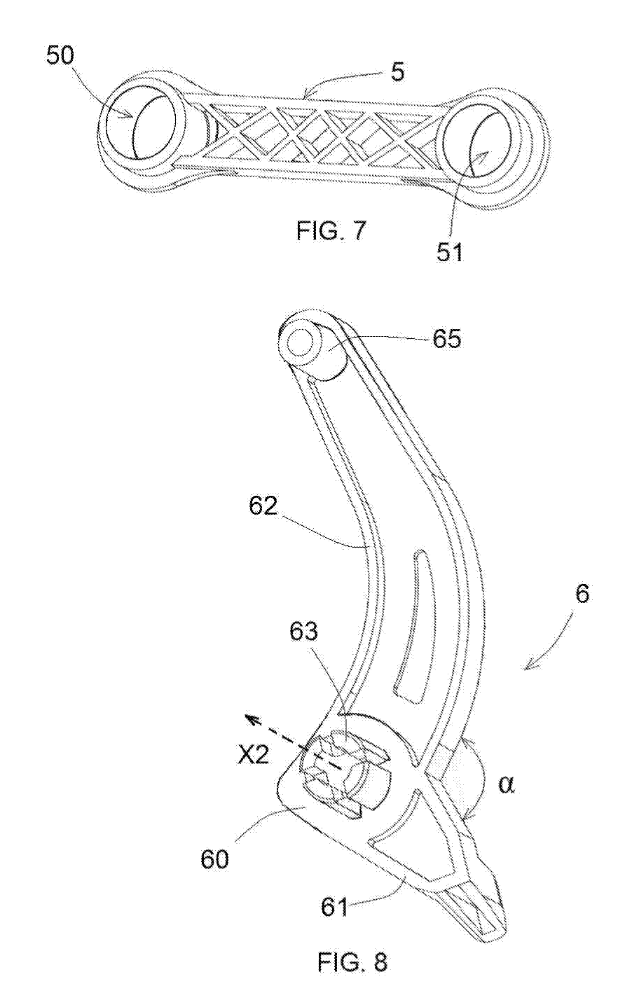

With reference to FIG. 7, the connection rod (5) is a straight rod with a first pivoting pin (50) at a first end, which is intended to be engaged with the eccentric pin (41) of the gear, and a second pivoting hole (51) at a second end.

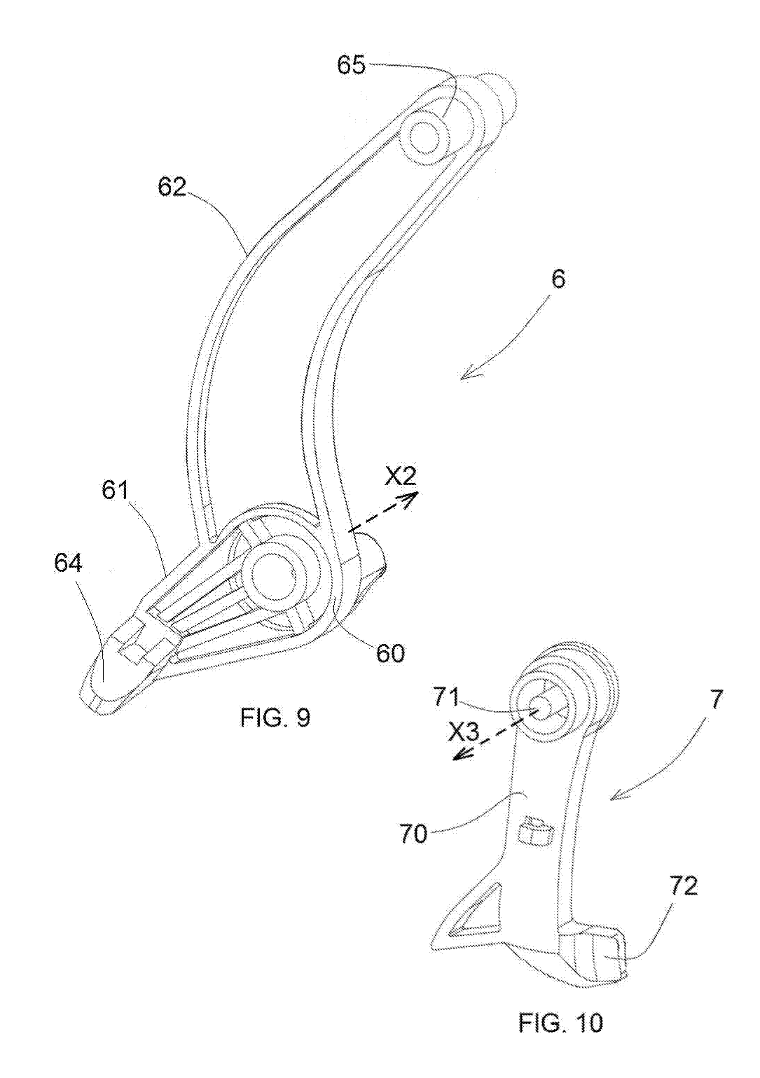

With reference to FIGS. 8 and 9, the actuation lever (6) has a basically “L” shape and comprises a central portion (60), a first arm (61) and a second arm (62). The first arm (61) is straight and shorter than the second arm (62). The second arm (62) is curved with convexity towards the direction of the first arm. An obtuse angle (α) is formed between the first arm (61) and the second arm (62).

A central pivoting pin (63) protrudes from the central portion (60) in order to be engaged inside the pivoting hole (51) of the connection lever, with a pivoting axis (X2) parallel to the axis of rotation (X1) of the gear and inclined with respect to the pivoting axis (Y1) of the lock hook.

With reference to FIG. 9, an actuation projection (64) protrudes at one end of the first arm (61), and is intended to stop against the actuation arm (13) of the lock hook in order to move the lock hook.

A pin (65) protrudes at one end of the second arm (62) on both sides of the second arm, in parallel direction to the axis of the central pivoting pin (63).

With reference to FIGS. 1 and 2, the lock (100) comprises a position detecting lever (7) that cooperates with the gear (4) to lock the gear (4) in a neutral position.

With reference to FIG. 10, the position detecting lever (7) has a rod-shaped body (70). A pivoting pin (71) is disposed at one first end of the position detecting lever in order to hinge the position detecting lever at the box of the lock with a pivoting axis (X3) parallel to the axis of rotation (X1) of the gear. A stop tooth (72) is positioned at a second end of the position detecting lever and protrudes from the body (70) of the position detecting lever in an orthogonal direction to the axis of the pivoting pin (71).

The stop tooth (72) of the position detecting lever is intended to be engaged inside the housing (42) of the gear. Spring means (not shown) stress the position detecting lever (7) towards the gear (4). The position detecting lever (7) is configured in such a way that when the motor (3) actuates the gear at the maximum power, the housing (42) of the gear is disengaged from the stop tooth (72) of the position detecting lever. On the contrary, when the motor actuates the gear at a lower power, for example with pulse width modulation (PWM) control logic, the stop tooth (72) of the position detecting lever remains engaged in the housing (42) of the gear, informing the motor (3) about the exact position of the gear that corresponds to a neutral position, in which the lock is not closed.

Other position detecting means can be provided instead of the position detecting lever (7) in order to detect the position.

Now referring to FIGS. 1 and 2, the lock (100) comprises an emergency opening device (S) intended to release the lock hook (1) and the locking latch (2) when the motor (3) is blocked. The emergency opening device (S) comprises a first lever (8) that actuates the actuation lever (6) and a second lever (9) that cooperates with the first lever (8) and actuates the locking latch (2).

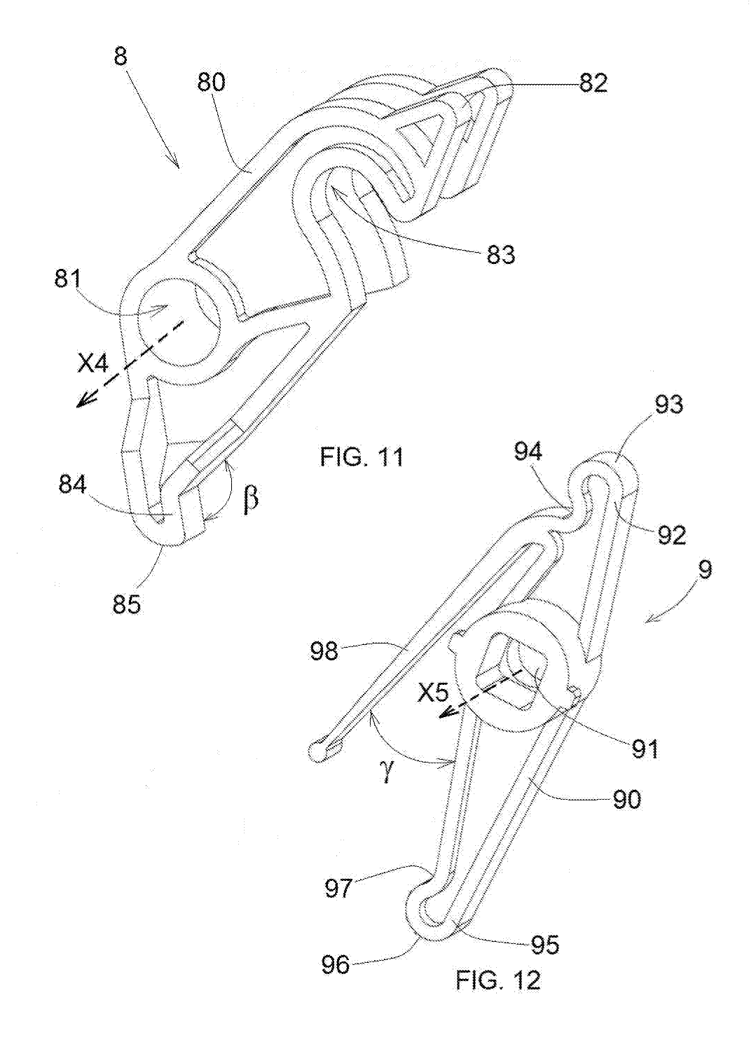

With reference to FIG. 11, the first lever of the emergency opening device comprises a body (80) shaped as a straight rod. A pivoting hole (81) is obtained in the body (80) for pivoting to the box that contains the lock, along a pivoting axis (X4) parallel to the axis (X2) of the central pivoting pin (63) of the actuation lever.

Wings (82) protrude at one end of the body (80), being intended to be manually actuated by the operator.

A “U”-shaped hooking slot (83) is obtained in the body (80) near the wings (82). The hooking slot (83) is intended to engage the pin (65) of the actuation lever.

A tooth (84) protrudes from the body (80) at the opposite end with respect to the end with the actuation wings (82). The tooth (84) forms an obtuse angle (β) with respect to the body (80). The tooth (84) has a rounded end (85). The tooth (84) must cooperate with the second lever (9).

With reference to FIG. 12, the second lever (9) of the emergency opening device comprises a body (90) shaped as a straight rod, provided with a central pivoting hole (91) for pivoting to the box that contains the lock, along a pivoting axis (X5) that is parallel to the axis (X2) of the central pivoting hole (81) of the first lever of the emergency opening device and inclined with respect to the axis (Y2) of the pivoting hole (21) of the locking latch.

A first tooth (92) is disposed at one first end of the body (90). The first tooth (92) has a rounded end (93) and a loop (94). The first tooth (92) of the second lever cooperates with the tooth (84) of the first lever in cam-follower mode.

A second tooth (95) is disposed at a second end of the body (90) of the second lever. The second tooth (95) has a rounded end (96) and a loop (97). The second tooth (95) of the second lever cooperates with the actuation projection (22) of the locking latch to release the locking latch.

The second lever (9) comprises an elastic wing (98) that protrudes from the body (9) forming an acute angle (γ). The elastic wing (98) acts as loading spring to load the second lever (9) of the 5 emergency opening device.

This description continues by illustrating the operation of the lock (100).

With reference to FIGS. 1 and 2, the lock is initially in a non-closing neutral position, in which the stop tooth (72) of the position detecting lever (7) is engaged in the housing (42) of the gear in such a way that the motor (3) exactly knows the starting position of the gear in order to guarantee a correct rotation of the gear (4).

The projection (64) of the actuation lever (6) is distant from the tooth (16) of the arm (13) of the lock hook. The tooth (23) of the locking latch (2) is in the positioning seat (15) of the lock hook.

The hooking slot (83) of the first lever of the emergency opening device is hooked in the pin (65) of the actuation lever. The tooth (84) of the first lever of the emergency opening device is in contact with the first tooth (92) of the second lever of the emergency opening device. The second tooth (95) of the second lever of the emergency opening device is in contact with the actuation projection (22) of the locking latch.

The electrical motor (3) is actuated in order to close the lock (100) in such a way to rotate the gear (4) along the direction of the arrow (F1). The maximum power of the electrical motor (3) is sufficient to release the stop tooth (72) of the position detecting lever from the housing (42) of the gear (4) to let the gear rotate.

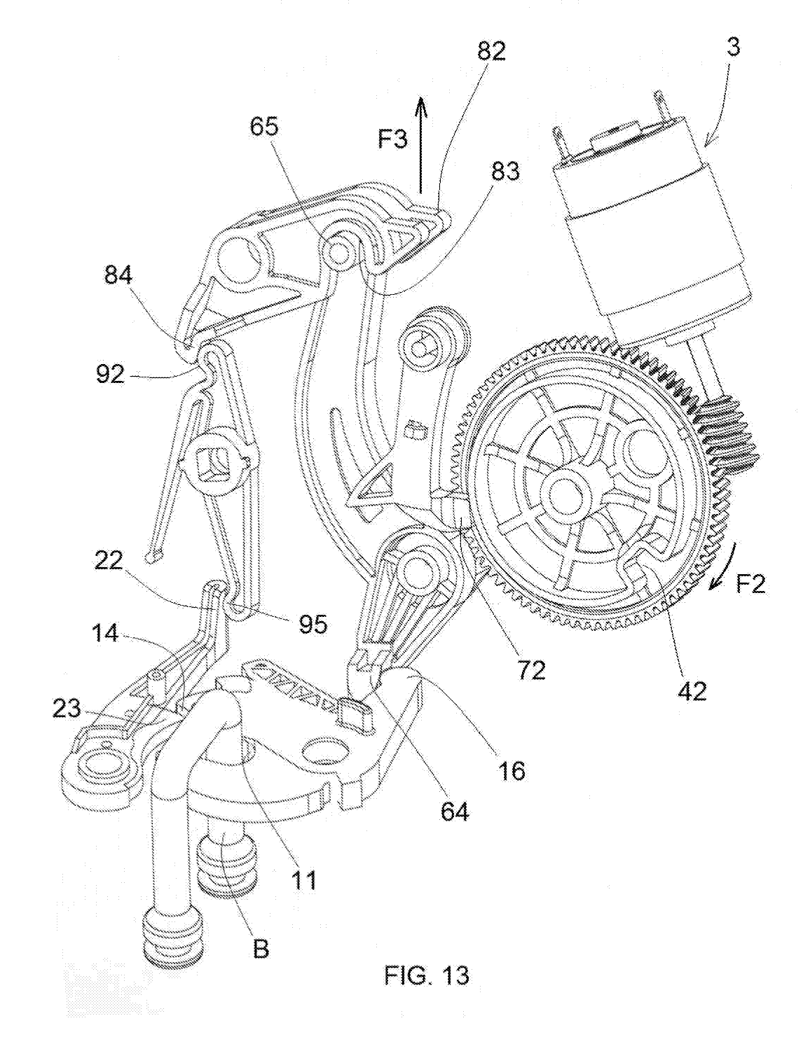

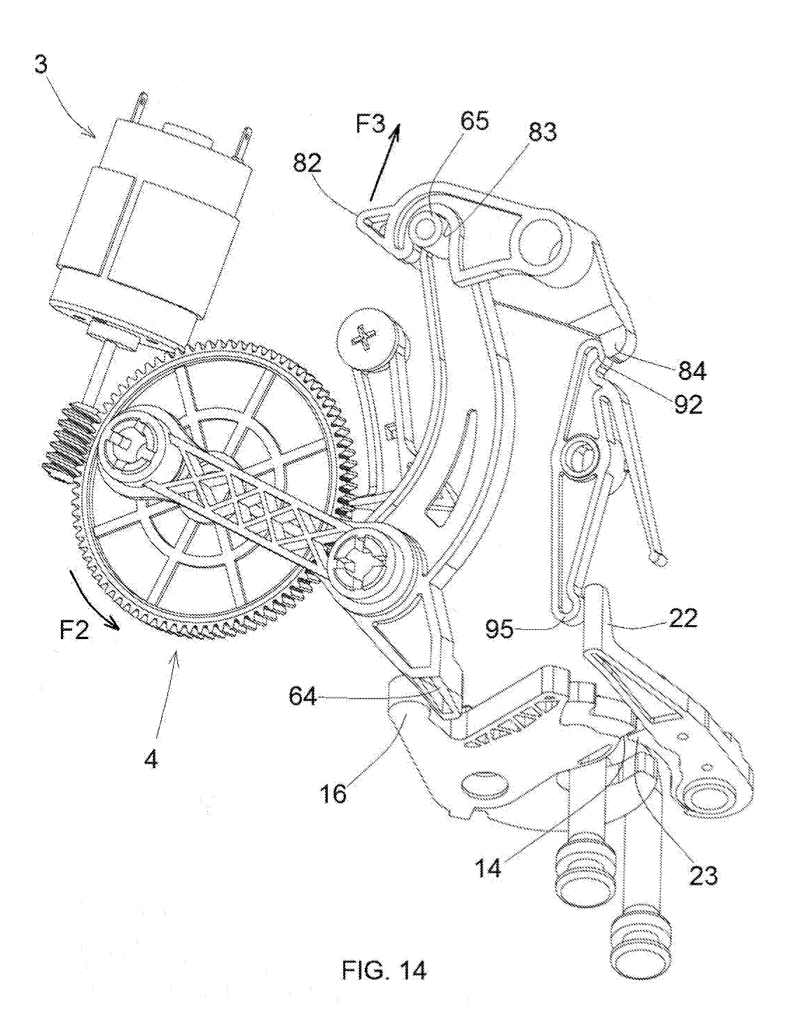

With reference to FIGS. 13 and 14, the stop tooth (72) of the position detecting lever is disengaged from the housing (42) of the gear. The rotation of the gear (4) determines a movement of the connection lever (5) and of the actuation lever (6) that is moved in such a way that the actuation projection (64) of the actuation lever is stopped against the tooth (16) of the arm of the lock hook, making the lock hook (1) rotate around its pivoting axis towards a closing position in which the slot (11) of the lock hook fastens the pin (B).

The stop tooth (23) of the locking latch slides on the edge of the lock hook and is positioned in the locking seat (14) of the lock hook, locking the lock hook in closing position. In such a situation, in which the lock is in closing position, the hooking slot (83) of the first lever of the emergency opening devices is hooked in the pin (65) of the actuation lever. The tooth (84) of the first lever of the emergency opening device is in contact with the first tooth (92) of the second lever of the emergency opening device. The second tooth (95) of the second lever of the emergency opening device is in contact with the actuation projection (22) of the locking latch.

If the motor (3) operates correctly, the lock (100) is opened by means of the motor (3) that makes the gear rotate along the direction of the arrow (F2).

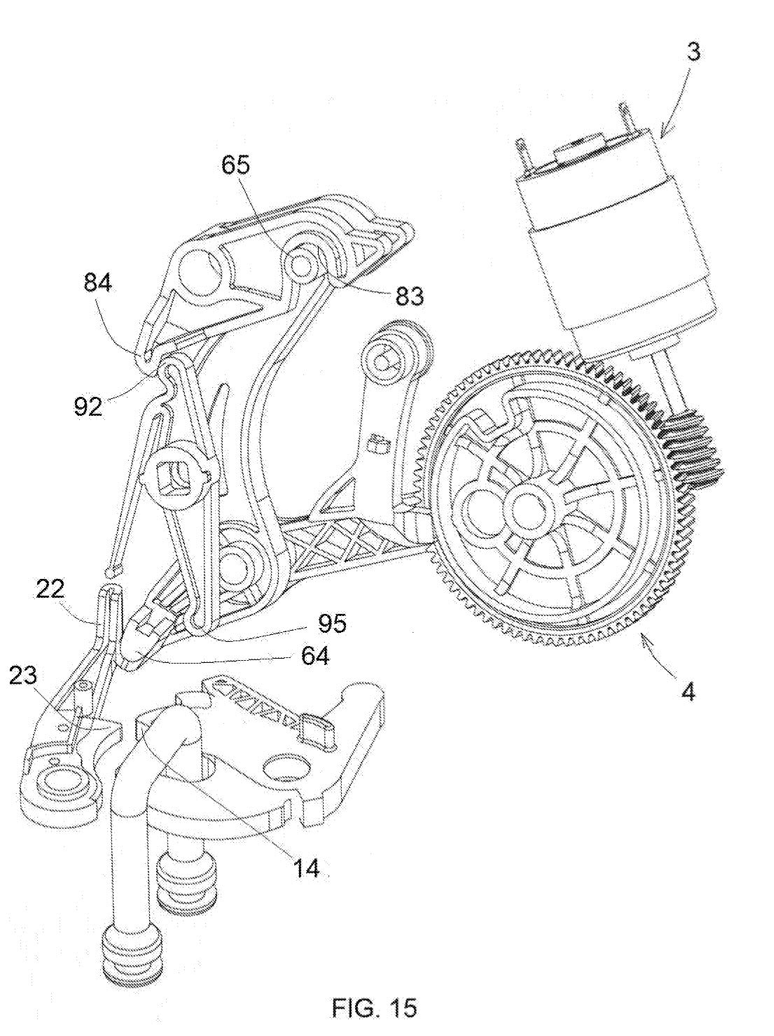

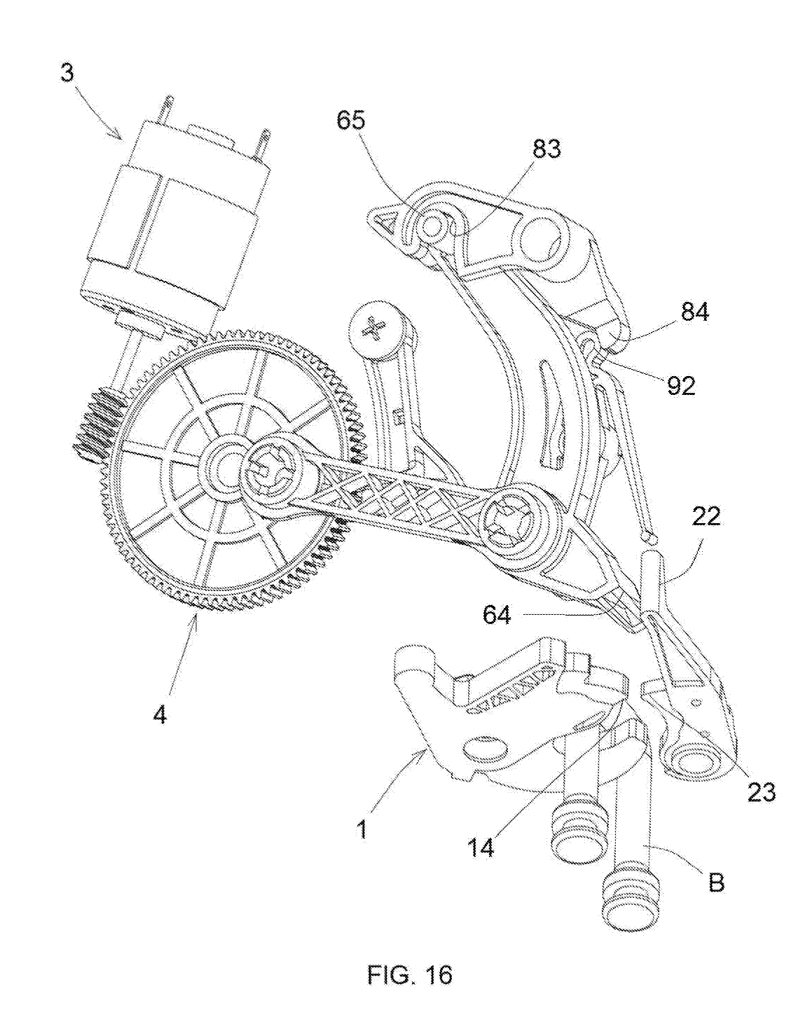

With reference to FIGS. 15 and 16, the rotation of the gear (4) causes a movement of the connection lever (5) and of the actuation lever (6) that is actuated in such a way that the actuation projection (64) of the actuation lever is stopped against the actuation projection (22) of the locking lath, making the locking latch rotate around its pivoting axis, in such a way that the stop tooth (23) of the locking latch is disengaged from the locking seat (14) of the lock hook, releasing the lock hook and opening the lock.

It must be noted that during the movement of the actuation lever (6), the actuation projection (64) of the actuation lever does not interfere with the second tooth (95) of the second lever of the emergency opening device. Therefore, the actuation projection (22) of the locking latch is moved apart from the second tooth (95) of the second lever of the emergency opening device. Consequently, in such a situation, in which the lock is in opening position, the hooking slot (83) of the first lever of the emergency opening devices is always hooked in the pin (65) of the actuation lever. The tooth (84) of the first lever of the emergency opening device is always in contact with the first tooth (92) of the second lever of the emergency opening device.

With reference to FIGS. 13 and 14, if the lock is in closing position and the motor (3) is not operating or is blocked, the operator must use the emergency opening device (S) to open the lock (100). In such a case the operator simply needs to move the first lever (8) of the emergency opening device manually, grabbing the wings (2) and lifting them along the direction of the arrow (F3).

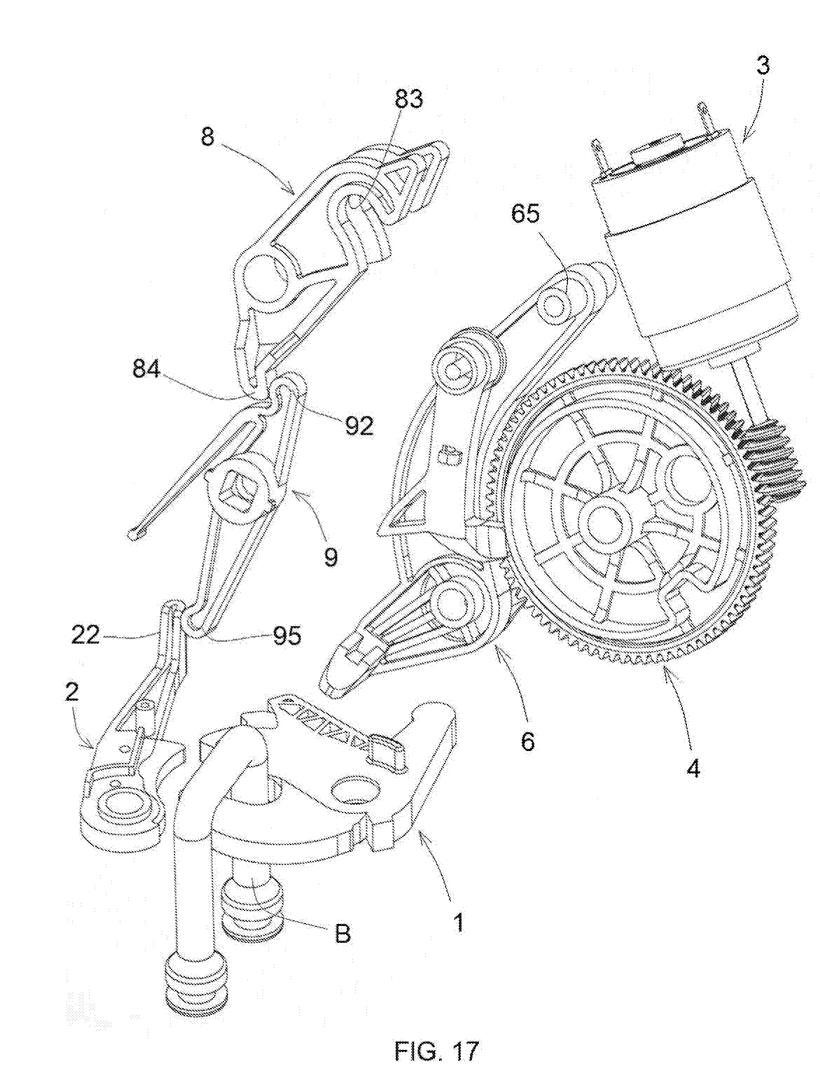

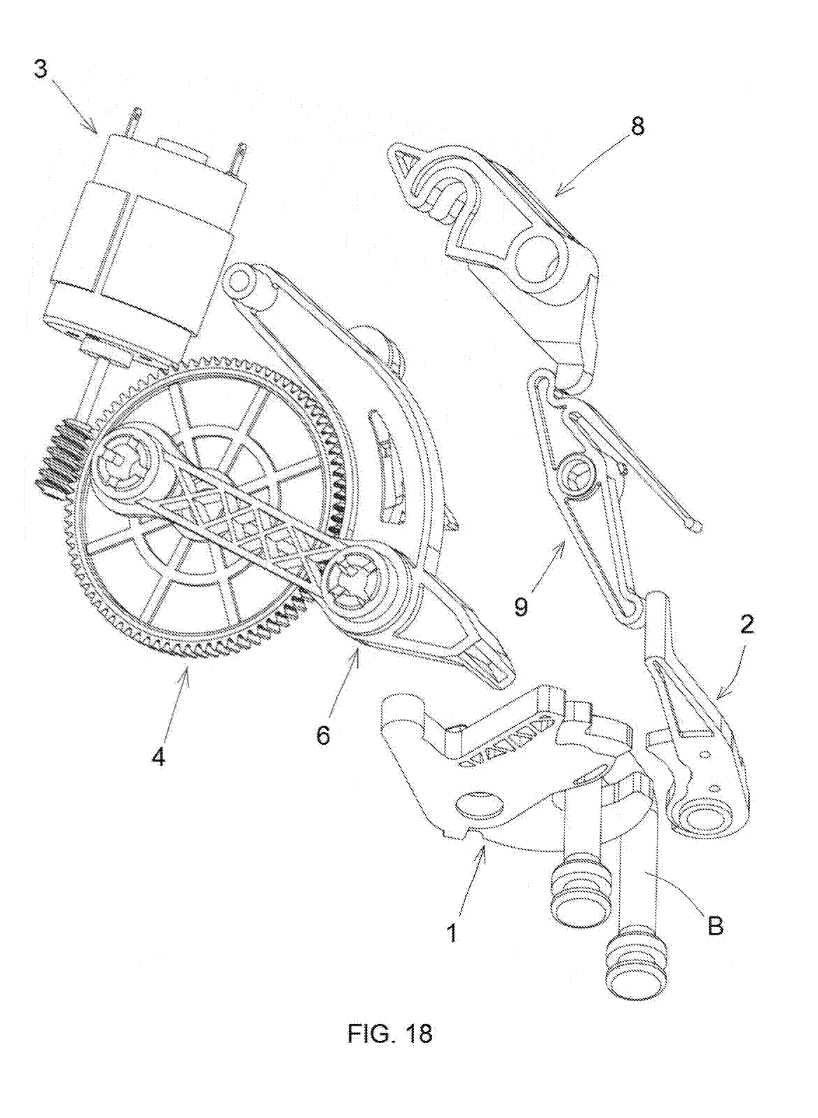

With reference to FIGS. 17 and 18, after actuating the first lever of the emergency opening device, the slot (3) of the first lever of the emergency opening device is disengaged from the pin (65) of the lever, releasing the actuation lever. During the actuation of the first lever (8) of the emergency opening device, the first lever (8) rotates around its pivoting axis and the tooth (84) of the first lever pushes the first tooth (92) of the second lever, making the second lever (9) rotate around its pivoting axis. Consequently, the second tooth (95) of the second lever pushes the projection (22) of the locking latch, making the locking latch rotate around its pivoting axis and disengaging the stop tooth (23) of the locking latch from the locking seat (14) of the lock hook.

In view of the above, the lock hook is free and is disengaged from the pin (B).

Numerous variations and modifications can be made to the present embodiment of the invention, which are within the reach of an expert of the field, falling in any case within the scope of the invention.

1. Lock for a motor vehicle door or lid comprising:
a lock hook hinged to a box of the lock, around a pivoting axis, said lock hook comprising a slot intended to hook a pin fixed to the body of the vehicle,
a locking latch hinged to the box of the lock around a pivoting pin and acting on said lock hook to lock the lock hook in closing position;
an actuation lever intended to actuate said lock hook,
an electrical motor that moves said actuation lever by means of a transmission,
an emergency opening device that can be manually actuated by the user to open the lock when the electrical motor is blocked, wherein said emergency opening device comprises:
a first lever detachably hooked to said actuation lever, and
a second lever that cooperates with the first lever and acts on said locking latch to release the locking latch from the locking position wherein it locks the lock hook.

2. The lock of claim 1, wherein said actuation lever is hinged to the box of the lock in a pivoting axis that is inclined with respect to the pivoting axis of the lock hook and said first lever and second lever of the emergency opening device are hinged to the box of the lock in pivoting axes parallel to the pivoting axis of the actuation lever.

3. The lock of claim 2, wherein said first lever of the emergency opening device comprises a hooking slot that is hooked to a pin of the actuation lever and a tooth and said second lever comprises a first tooth that cooperates with said tooth of the first lever and a second tooth that cooperates with an actuation projection of the locking latch.

4. The lock of claim 3, wherein said actuation lever has an L-shape and comprises:
a central portion,
a first arm provided with an actuation projection that cooperates with an actuation arm of said lock hook, and
a second arm having said pin that is engaged in said hooking slot of the first lever of the safety opening device.

5. The lock of claim 1, wherein said transmission that transmits the motion from the electrical motor to the actuation lever comprises a gear and a connection lever that connects the gear to the actuation lever.

6. The lock of claim 5, wherein said gear comprises an eccentric pin connected to said connection lever and said actuation lever comprises a central pin connected to said connection lever.

7. The lock of claim 5, comprising position detecting means that act on said gear to detect the position of said gear.

8. The lock of claim 7, wherein said position detecting means comprise a position detecting lever hinged to said box of the lock in a pivoting axis and provided with a stop tooth that is engaged in a housing of said gear.

9. The lock of claim 8, wherein said housing of the gear is obtained as a radial recess on a cylindrical collar that protrudes from one side of the gear.

10. The lock of claim 5, wherein said electrical motor comprises a geared motor having an output shaft whereon a worm screw that engages in said gear is mounted.
